(19) United States
(12) Patent Application Publication
(10) Pub. No.: US 2008/0192906 A1
(43) Pub. Date: Aug. 14, 2008

(54) METHOD AND SYSTEM FOR MESSAGE MANAGEMENT FOR AUDIO STORAGE DEVICES

(75) Inventors: JIANN CHERNG LUH, San Jose, CA (US); CHIN-SHU LIN, Cupertino, CA (US); GEOFF JACKSON, Mountain View, CA (US); BRIAN YANG, San Jose, CA (US); WENKUEI CHEN, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Winbond Electronics Corporation, Hsinchu (TW)

(21) Appl. No.: 11/675,070

(22) Filed: Feb. 14, 2007

(51) Int. Cl. H04M 1/64

(52) U.S. Cl. 379/88.28

(57) ABSTRACT

A method for message management for an audio storage device. The audio storage device includes first segment for storing address information, second segment for storing prerecorded audio data, third segment for storing voice macro scripts, fourth segment for storing user data and reserved messages, and fifth segment for storing audio messages. Address information of the prerecorded audio data and the voice macro script is stored in the first segment. Address information of the audio message is stored in the fourth segment. The method includes receiving an index to a voice macro script, which includes one or more voice macro commands. The method including accessing the first segment of the audio storage device for information related to a starting location of the voice macro script in the third segment. The method retrieves a voice macro command in the third segment; and performs an action related to the retrieved voice macro command.

### BACKGROUND OF THE INVENTION

The present invention is directed to audio message management. More particularly, the invention provides a method and system for a message management for audio storage devices. Merely by way of example, the invention has been applied to audio storage devices for recording and playback. But it would be recognized that the invention has a much broader range of applicability. For example, the invention can be applied to TIM for the automotive, TAD (Telephone Answering Device), security systems with personalized voice prompts, Voice GPS systems, and other voice applications, etc.

As is known, certain conventional audio storage systems use micro-controller/processor with control software to manage the messages. For example, the software handles operation such as record, play, erase and forward. During recording, the control software needs to search for empty memory cell for storing the incoming audio data. In an example, the empty memory cells could locate in the memory randomly. A conventional method may include the following steps:

(1) find empty memory;

(2) write audio data to memory; and

(3) store all the address information.

To playback the message using conventional methods, a user may retrieve the audio data from memory in the same order it was recorded. The address information is typically stored in a memory such as a RAM or a flash memory. These conventional methods have many limitations. For example if address information is stored in a RAM, when power is removed, the address information can be lost. This can happen, for example, when it is necessary to replace a battery. Another way is to store address information on flash memory. This can prevent data lost due to power removed. However, this will induce cost increase due to the use of additional flash memory. These and other limitations will be discussed in detail below.

From the above, it is seen that an improved technique for audio message management is desired.

### BRIEF SUMMARY OF THE INVENTION

The present invention is directed to audio message management. More particularly, the invention provides a method and system for a message management for audio storage devices. Merely by way of example, the invention has been applied to audio storage devices for recording and playback. But it would be recognized that the invention has a much broader range of applicability. For example, the invention can be applied to TIM for the automotive, TAD (Telephone Answering Device), security systems with personalized voice prompts, Voice GPS systems, and other voice applications, etc.

According to an embodiment of the invention, a method is provided for audio message management. The method includes providing an audio storage device. In an embodiment, the audio storage device includes first segment for storing address information and second segment for storing prerecorded audio data. A starting address and an ending address of the prerecorded audio data are stored in the first segment. The audio storage device includes a third segment for storing at least a plurality of voice macro scripts. Each of the plurality of voice macro scripts includes one or more voice macro commands. A starting address and an ending address associated with each of the plurality of the voice macro scripts are stored in the first segment. The audio storage device also includes fourth segment for storing user data and a first sector of user reserved audio message, and fifth segment for storing at least an audio message. Starting address information of the audio message is stored in the fourth segment. For executing a voice macro script, the method receives an index for one of a plurality of voice macro scripts, which includes one or more voice macro commands. The method accesses the first segment of the audio storage device for information related to a starting location of for the voice macro script associated with the index. The starting location is in the third segment of the audio storage. The method retrieves a voice macro command in the third segment of the audio storage, and performs an action according to the retrieved voice macro command.

In a specific embodiment, the audio storage device is a non-volatile memory device. For example, the audio storage device can be a flash memory device. In an embodiment, the voice macro script includes a voice macro script start marker, one or more voice macro commands, and a voice macro script end marker. In a specific embodiment, the one or more voice macro commands include a command to playback prerecorded audio data. The method includes receiving the command to playback prerecorded audio data. The command also includes a starting address of the prerecorded audio data. The method reads the prerecorded audio data in the second segment of the audio storage device and plays the prerecorded audio data. In another embodiment, the one or more voice macro commands include a command to play a recorded audio message. The method further includes receiving the command to playback a recorded audio message. The command includes identification information of the recorded audio message. The method accesses the fourth segment of the audio storage device to retrieve a starting address for the recorded message, reading the recorded audio message in the fifth segment of the audio storage device and plays the recorded audio message. In yet another embodiment, the one or more voice macro commands include a command to insert a delay, or a command to play a silence message, or a command to change volume, or a command to change configuration. In an embodiment, the method includes receiving an audio data, storing the audio data in the second segment of the audio storage device, and storing a starting address and an ending address of the audio data in the first segment of the audio storage device. In another embodiment, the method includes selecting a starting address in the third segment of the audio storage device, storing the audio data in the third segment of the audio storage device, and storing the starting address and an ending address of the audio data in the first segment of the audio storage device. In a specific embodiment, the method includes receiving a command to record an audio message, selecting an available sector in the fifth segment of the audio storage device, storing a begin-of-message marker in a header, and storing the audio message in the sector. In an embodiment, the method includes selecting a second sector for audio message storage and storing a second sector address marker in a header of the first sector. The method also includes storing an end of message marker in a header of a last sector for storing the audio message. In an embodiment, the method receives a command to play a recorded audio message, which includes a starting address for the recorded audio message. The method reads a header for a end of message marker and plays the recorded audio message. The method stops the playing if the end of message marker is found. In yet another embodiment, the method receives a command to erase a recorded audio message. The command includes a starting address for the recorded audio message. The method reads a header for a begin-of-message marker, and erases the recorded audio message. The method sends an error message if the begin-of-message marker is not found.

According to another embodiment, the invention provides a semiconductor memory device for audio data storage. The memory device includes first plurality of memory cells for storing address information and second plurality of memory cells for storing prerecorded audio data. In an embodiment, at least a starting address of the prerecorded audio data is stored in a selected one of the first plurality of memory cells. The memory device includes third plurality of memory cells for storing at least a voice macro script. In an embodiment, at least a starting address of the voice macro script is stored in a second selected one of the first plurality of memory cells. The memory device includes fourth plurality of memory cells for storing user data and fifth plurality of memory cells for recording at least an audio message. At least an address information of the audio message is stored in a selected one the fourth plurality of memory cells.

In a specific embodiment, the prerecorded audio data includes English words. In another embodiment, prerecorded audio data includes foreign language words. In yet another embodiment, the prerecorded audio data includes non-verbal data, such as a Beep-tone. In a specific embodiment, the voice macro script includes a voice macro start marker, one or more voice macro commands, and a voice macro end marker. The one or more voice macro commands include a command to playback a prerecorded audio data, a command to insert a delay, a command to play a silence message, a command to change volume, a command to change configuration, or a command to play a recorded audio message. In a specific embodiment, the fourth plurality of memory cells includes sectors, which are characterized by capacities in the range of approximately 4 K bytes to 64 K bytes. In an embodiment the fifth plurality of memory cells includes sectors, which are characterized by capacities in the range of approximately 4 K bytes to 64 K bytes. In an embodiment, the storage device is a non-volatile memory device. In another embodiment, the audio storage device is a flash memory device.

In an alternative embodiment, a method is provided for playing an audio message stored in an audio storage device. The method includes receiving an index to a segment in the audio storage device. The segment includes a first address for a prerecorded message and a second address for a voice macro script. The voice macro script includes a predetermined sequence of voice commands. In an example, the index is associated with the second address for the voice macro script. The method includes reading the second address for the voice macro script associated with the index and retrieving a voice command in the voice macro script. The method determines if the voice command includes a command to play a user reserved message. The method also determines if the user reserved message is recorded in the audio storage device. If the user reserved message is not recorded in the audio storage device, the method records the user reserved message. The method then plays the user reserved message. In a specific embodiment, the voice macro command includes a command to playback a prerecorded audio data, a command to insert a delay, a command to play a silence message, a command to change volume, a command to change configuration, or a command to play a recorded audio message. In another embodiment, the audio storage device includes first segment for storing address information, second segment for storing prerecorded audio data. A starting address and an ending address of the prerecorded audio data are stored in the first segment. The audio storage device also includes third segment for storing at least a voice macro script. A starting address and an ending address of the voice macro script are stored in the first segment. The audio storage device also includes fourth segment for storing user data and a first sector of user reserved audio message, and fifth segment for storing at least an audio message. Starting address information of the audio message is stored in the fourth segment.

Many benefits are achieved by way of the present invention over conventional techniques. For example, in specific embodiments, techniques are provided for message management for an audio storage device that reduce message programming effort and shortens the project development cycle. In an embodiment, the invention provides message management methods that can be used for multi-language applications. In a specific embodiment, methods are provided for using voice prompts (VPs) and voice macros (VMs) for improved message management. For example, the VPs can be re-used in different VMs to reduce memory size for cost saving. In an embodiment, a method is provided to issue Play VM command to execute a voice macro script without the needs to handle the playback task on individual word in a complicated control program that consumes more processor power. Depending upon the embodiment, one or more of these benefits may be achieved. These and other benefits will be described in more detail throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified block diagram of an audio data storage according to a specific embodiment of the invention;

FIG. 2 is a simplified flow diagram of a method for an audio message management according to an embodiment of the present invention; and

FIGS. 3a and 3b are simplified view diagrams of an audio data storage according to another embodiment of the invention.

### DETAILED DESCRIPTION OF THE INVENTION

The present invention is directed to audio message management. More particularly, the invention provides a method and system for a message management for audio storage devices. Merely by way of example, the invention has been applied to audio storage devices for recording and playback. But it would be recognized that the invention has a much broader range of applicability. For example, the invention can be applied to TIM for the automotive, TAD (Telephone Answering Device), security systems with personalized voice prompts, Voice GPS systems and other voice applications, etc.

As discussed above, conventional methods for audio message management have many limitations. For example, conventional methods usually use large memory storage and involve complicated steps such as finding available memory space and tracking audio message storage locations, etc. In addition, using conventional methods for multi-language product, a user may need to modify the software for different languages. This will increase programming effort and cost. Therefore an improved technique for audio message management is desired.

Depending upon the embodiment, the present invention includes various features, which may be used. These features include the following:

1. Prerecorded voice prompts and other voice commands for message construction;

2. Methods for managing voice macro scripts for message management;

3. Message management methods applicable to multiple languages; and

4. An efficient audio storage device memory partitioning method.

As shown, the above features may be in one or more of the embodiments to follow. These features are merely examples, which should not unduly limit the scope of the claims herein. One of ordinary skill in the art would recognize many variations, modifications, and alternatives.

According to an embodiment of the invention, a message management method is provided for audio message playback. In another embodiment, a method is provided for audio message record and playback. In yet another embodiment, a method is provided for playback with optional recording. Depending on the embodiment, the methods can handle a task from a single play to a sequence play. In a specific embodiment of the present invention, an audio message can be defined as a Voice Prompt (VP). For example, “you”, “how”, and “are” are three individual voice prompts. In an embodiment, the voice prompts include prerecorded messages. In an embodiment, a sentence can be programmed with a sequence of VPs. For example, a user can cascade three voice prompts, “you”, “how”, and “are” into a sequence “How are you” which can be a sentence. In certain embodiments, non-audio messages can also be included in a sequence. For example, to make the playback audio message resemble a human speaking quality, a “silence” prompt can be inserted between VPs in a specific embodiment. In another example, a “Beep-tone” prompt can be included in a sequence. Of course, there can be other modifications, variations, and alternatives.

According to an embodiment of the invention, the method for message management includes Voice Macros (VMs). In a specific embodiment, a VM includes a predetermined sequence of VPs and commands. Examples of macro commands include “play a VP”, “delay 1 second”, “change volume”, and “play msg@R1” where R1 is an address in an audio database, etc. Certain embodiments of the invention provide methods for forming custom voice macro scripts which may include voice macro commands such as “play a sequence of VPs”, “record message”, “play message”, and “insert silence”, etc. The voice commands can also include “change the configuration” such as setting the volume, changing sampling frequency, selecting output path, and setting input audio gain, etc. Of course, there can be other modifications, variations, and alternatives.

In a specific embodiment, each VM script is ended with “End of VM” command. The VMs are stored in an audio message database. For example, the VMs can be stored in the database memory sequentially. In another example, the VMs can be stored in random order in the database memory. In an embodiment, a VP can be re-used in different VMs. For example, various VMs can be programmed using VPs selected from a given set of pre-recorded VPs. In an embodiment, the VP and VM are addressed by indirect indices. VP and VM content can be modified without affecting the index numbers. For example, VPs and VMs programmed in different languages can use the same indices, allowing an audio management system to be used in different applications. In an embodiment, a user can build up VPs and VMs using VP and VM control commands. After a user has created the VPs and VMs, memory mapping information can be created. This mapping can be programmed into a memory in a message management system. An example of memory mapping in an audio data storage is discussed below.

According to an embodiment of the invention, the audio data storage includes several segments. For example, the segments can include that following:
1. First segment for storing address information;
2. Second segment for storing prerecorded audio data;
3. Third segment for storing at least a voice macro script;
4. Fourth segment for storing user data and the first sector of user reserved messages; and
5. Fifth segment for recording an audio message, etc.
   Of course, there can be other modifications, variations, and alternatives, depending upon the embodiment.

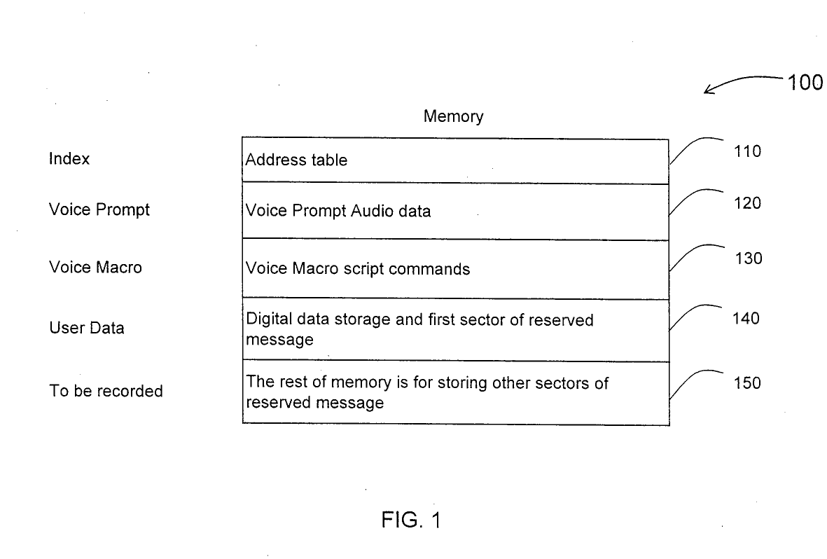

FIG. 1 is a simplified block diagram of an audio data storage according to a specific embodiment of the invention. This diagram is merely an example, which should not unduly limit the scope of the claims herein. One of ordinary skill in the art would recognize other variations, modifications, and alternatives. In a specific embodiment of the present invention, an audio storage 100 is partitioned into five segments, 110-150, as shown in FIG. 1.
1. Index segment (110): for storing VM/VP address table;
2. Voice prompt segment (120): for pre-stored audio data storage;
3. Voice Micro segment (130): for storing voice micro script data;
4. User data segment (140): for digital data storage and first sector of the reserved to-be-recorded audio data.
5. To-be-recorded segment (150): for storing the recorded message/audio data.
   In an embodiment, the database is implemented in a memory device, for example, a semiconductor memory device. In a specific example, the semiconductor memory can be a non-volatile memory, for example, a Flash memory. In another example, the User Data is further divided in to sectors. The To-be-recorded segment can also be divided into sectors. In an embodiment, the sector size can be approximately 4 Kbyte to 64 Kbyt, depending on the embodiments. Of course, there can be other variations, modifications, and alternatives. Some examples of techniques for message management using storage partitioning are described below.

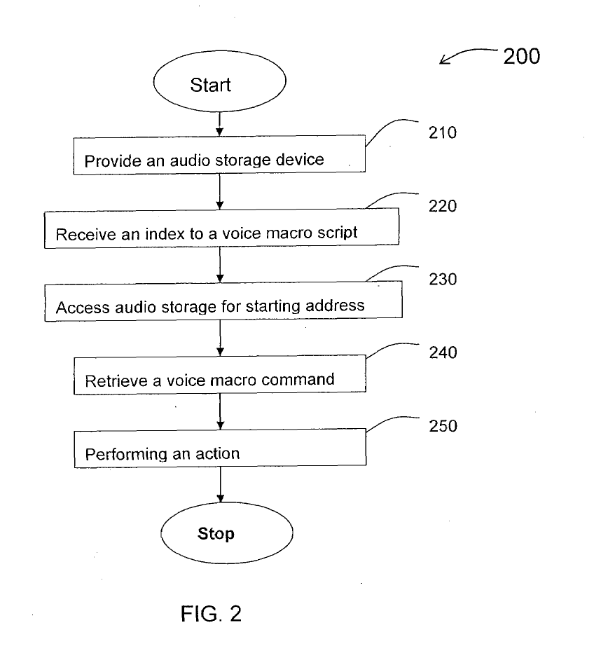

FIG. 2 is a simplified flow diagram of a method for an audio message management according to an embodiment of the present invention. This diagram is merely an example, which should not unduly limit the scope of the claims herein. One of ordinary skill in the art would recognize other variations, modifications, and alternatives. As shown, the method for audio message management according to an embodiment of the present invention can be briefly outlined below.
1. (Process 210) Provide an audio storage device;
2. (Process 220) Receive an index to a voice macro script;
3. (Process 230) Access the audio storage device for starting location of the voice macro script;
4. (Process 240) Retrieving a voice macro command; and
5. (Process 250) Performing an action related to the retrieved voice macro command.

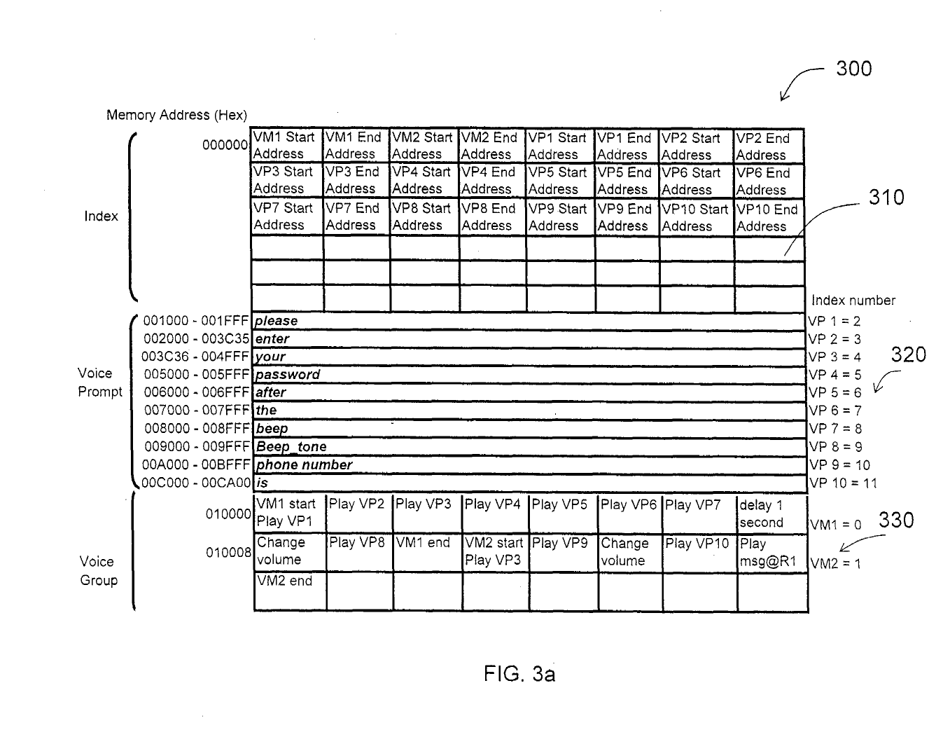

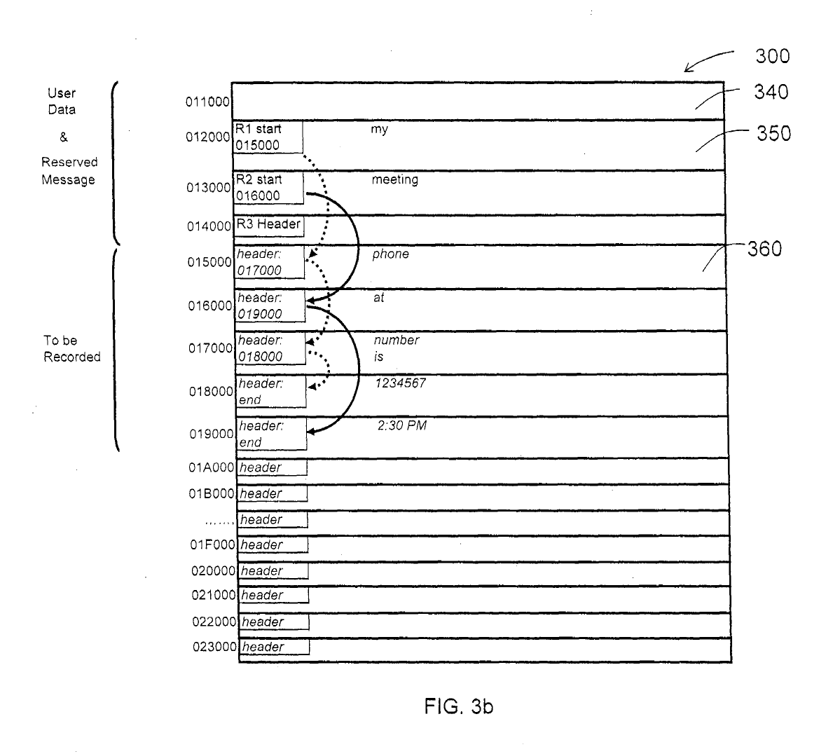

The above sequence of processes provides a method for message management according to an embodiment of the present invention. As shown, the method uses a combination of processes including a way of providing an audio storage device and executing a voice macro command. Other alternatives can also be provided where processes are added, one or more processes are removed, or one or more processes are provided in a different sequence without departing from the scope of the claims herein. As shown, in Process 210, the method of audio message management according to an embodiment of the invention starts with providing an audio storage device. An example of such an audio storage device according to a specific embodiment of the invention is shown in FIGS. 3a and 3b. Further details of the present method can be found throughout the present specification and more particularly below.

FIGS. 3a and 3b are simplified view diagrams of an audio data storage 300 according to a specific embodiment of the invention. These diagrams are merely examples, which should not unduly limit the scope of the claims herein. One of ordinary skill in the art would recognize other variations, modifications, and alternatives. As shown, audio storage 300 includes segments of storage in this specific embodiment. Merely as an example, a storage allocation includes the following segments:

Index segment 310: from 000000 to 000FFF;

Voice prompt segment 320: from 001000 to 00CA00;

Voice Micro segment 330: from 010000 to 010FFF;

User data segment 340: from 011000 to 014FFF;

To-be-recorded segment 360: from 015000 to 019FFF.

It is understood that this particular mapping is only an example. Depending on the embodiments, there can be other variations, modifications, and alternatives.

As shown in FIGS. 3a and 3b, an audio storage according to an embodiment of the invention includes several segments. In FIG. 3a, Segment 310 is the first segment for storing address information. Segment 320 is a second segment for storing prerecorded audio data. As shown in FIG. 3a, prerecorded audio data, also referred to as voice prompts (VPs) in a specific embodiment, “please”, “enter”, . . . “phone number”, “is”, etc, as well as non-speaking audio data such as “Beep-tone” are stored in segment 320. A starting address and an ending address of the prerecorded audio data are stored in the first segment 310. For example, VP1 Start Address and VP1 End Address are stored in the first row in segment 310. Also shown in FIG. 3a, segment 330 is the third segment for storing at least a voice macro script. For example, a first VM includes VM1 start, Play VP1, Play VP2, . . . , Play VP8, and VM1 end, etc. A starting address VM1 Start Address and an ending address VM1 End address of the voice macro script VM1 are stored in the first segment, starting from location 000000, for example. As shown in FIG. 3b, Segment 340 is the fourth segment for storing user data and a first sector of user reserved message, and segment 360 is the fifth segment for recording at least an audio message. In a specific embodiment, segment 360 is used to store part of the user reserved message. The segment 340 also includes next sector address of the audio message. For example, reserved message R1 starts at 012000. After the first sector of message R1, e.g. “my”, is recorded, the rest of message R1 is stored in a sector in the “to-be-recorded” segment. In a specific example, “phone” is stored in the sector starting at location 015000. In an embodiment, the next sector address 015000 is stored in the fourth segment. A header in the segment starting at 015000 also includes an address for the next sector for message R1. For example, “number is” is stored in a sector starting from 016000 and “1234567” is stored in a sector starting at 018000. Following header information, a message of “my phone number is 1234567” can be retrieved. In a specific embodiment, the prerecorded audio data and stored audio message are English words. In other embodiments, the prerecorded audio data and stored audio message can be words in a foreign language, or non-English words. Of course, there can be other variations, modifications, and alternatives.

Referring back to FIG. 2, the method of audio message management according to an embodiment of the invention includes various operations with respect to the information in the audio storage. For example, according to a specific embodiment of the invention, a method is provided for executing a voice macro (VM). As a specific example, a VM includes a predetermined sequence of VPs and VM commands. For instance, a voice macro script may include a voice macro script start marker, one or more voice macro commands, and a voice macro script end marker. In an specific embodiment, the method assigns an index number for each VM. In Process 220, for example, the method receives an “Execute VM” command with an index number which selects a particular VM in the audio storage. For example, an “Execute VM” command with a VM index 0 selects VM1 Start Address in Segment 310 in FIG. 3a. Of course, there can be other variations, modifications, and alternatives.

In Process 230, the method follows VM1 Start Address and accesses the third segment 330 of the audio storage device 300 for information related to a starting location of the voice macro script. In Process 240, the method retrieves a voice macro command and in Process 250 the method performs an action related to the retrieved voice macro command. For example, VM1 Start Address points to VM command Play VP1, which causes “please” to be played at an output device, for example, a speaker. The method then repeats Process 240 and Process 250 to retrieve a VM command and performs the action prescribed by the VM. Using VM1 as an example, the method causes the message “please enter you password after the beep” to be played, followed by a Beep-tone. In this particular example, a VM includes commands to play a pre-recorded audio data. The pre-recorded audio data, also referred to as voice prompts (VPs) can include English words, non-English words such as a Beep-tone, or words in other languages. Of course, there can be other variations, modifications, and alternatives.

In an alternative embodiment, a method is provided for incorporating one or more reserved messages into a VM script. For example, the VM2 script in Segment 3 includes a VM command such as “play msg@R1”, where R1 is an address associated with a reserved message in an audio database. In an embodiment, the audio message at R1 will be played when script VM2 is executed. For example, referring back to in FIG. 3a, to execute VM2 (index=1), the method receives an “Execute VM” command with index 1, then the message “your phone number is+message R1” is played back, following the “Play VP3”, “Play VP9”, “Play VP10”, and “Play msg@R1” commands. In a specific embodiment, the “change volume” command in the row starting with location 010008 changes the speaker output volume. As shown in FIG. 3b, the message R1 is a reserved message in segment 340 that can be recorded by a user. In an embodiment, the method determines if the first sector at address R1 has been recorded by checking a header. For example, if a sector has been recorded, a “full” marker and a “begin-of-message” marker are set in the header. If the R1 has not been recorded yet, as indicated by header information, only “your phone number is” is played back. In a specific embodiment, a method is provided for recording a reserved message which is not included in the list of pre-recorded voice prompts. Depending on the embodiment, the reserved message may be recorded by the user prior to the execution of the voice prompt that activates the reserved message starting at address, for example, R1. In an alternative embodiment, address R1 may refer to a message which has not yet been recorded in the audio data base, as discussed below. Of course, there can be other variations, modifications, and alternatives.

In a specific embodiment, if the reserved message has not been recorded yet, the method reserves a sector in the segment for user data and reserved messages and sets up a header in the sector to reserve this sector as the first sector of the reserved message. The header may include a few digital bits or bytes located in the beginning of each sector. In an embodiment, a header includes information such as sector status (e.g., empty/full), next sector address, audio type, begin-of-message, and end of message, etc. After the sector is reserved, the sector address can be used in recording a new message. Of course, there can be other variations, modifications, and alternatives.

The above sequences of processes provide a method for executing a voice macro script in a message management for an audio data storage according to an embodiment of the present invention. As shown, the method uses a combination of processes including a way of providing prerecorded audio messages, voice macro commands, and adding recorded messages for the management of audio messages. Other alternatives can also be provided where processes are added, one or more processes are removed, or one or more processes are provided in a different sequence without departing from the scope of the claims herein. Further details of the present method can be found throughout the present specification and particularly below.

In an alternative embodiment of the present invention, a method is provided for playing a recorded audio message as may be required in a voice macro command. The method includes receiving the command to playback a recorded audio message. In a specific embodiment, the command includes an identification number of the recorded audio message. The method includes accessing the fourth segment of the audio storage device to retrieve a starting address for the recorded message. The method also includes reading the recorded audio message in the fifth segment of the audio storage device, and playing the recorded audio message.

In another embodiment, a voice macro command may be a command to insert a time delay, or a command to play a silence message, or a command to change playback volume, or a command to change configuration of the playback equipment. A method is provided to insert a time delay, to play a silence message, to change playback volume, or to change configuration of the playback equipment, respectively, in response to the voice macro commands. Of course, there can be other variations, modifications, and alternatives.

In yet another embodiment of the invention, a method is provided for storing an audio message to be used later as a prerecorded message. For example, a prerecorded message may be a voice prompt (VP). In another example, a prerecorded message may be a non-speech sound, e.g. a beep-tone. The method includes receiving an audio data, and storing the audio data in the second segment of the audio storage device, e.g., segment 320 in FIG. 3a. The method then stores a starting address and an ending address of the audio data in the first segment of the audio storage device, e.g., in segment 310 in FIG. 3a. In yet another embodiment of the invention, a method is provided for storing a voice command as part of a voice macro script. The method includes selecting a starting VM address in the third segment of the audio storage device, e.g. segment 330 in FIG. 3a. The method stores the audio data in the third segment of the audio storage device. The method also stores a starting address and an ending address of the audio data in the first segment of the audio storage device. Of course, there can be other variations, modifications, and alternatives.

In a specific embodiment, a method is provided for recording input audio data in the fifth segment of the audio storage, i.e., the “to-be-recorded” memory segment 360 as shown in FIG. 3b. In an example, a minimum record duration of audio data is stored in one sector of audio storage memory. In a specific embodiment, a sector can have a capacity of approximately 4 K bytes to 64 K bytes. Depending on the embodiment, other suitable sector sizes can also be used. In an embodiment, it is not necessary to specify a starting address in a record command. A header portion of a sector is reserved for linking purposes. In a particular embodiment of the invention, a method is provided for searching for an available or empty memory sector to start the record operation. In an embodiment, a “begin-of-message” marker is set in the header, when a recording is started. After a sector is filled up with incoming audio data, the method searches for an empty sector to continue the recording. After the next sector is found, the next sector address will then be written back to the header of the previous sector under the “next sector address” area. Each sector contains next sector's address for the audio message. In an embodiment, recording will continue until it runs out of memory or a stop command is issued. After completing the record operation, the method sets up an “end of message” marker to indicate this is the last sector of the message so playback will stop at this sector. In a specific embodiment, the marker can be made as a binary bit on the header of the last sector. In an embodiment, the method returns the address of initial sector, which can be stored in the user data segment for playback purpose. Of course, one of ordinary skill in the art will recognize other variations, modifications, and alternatives.

In certain embodiments of the invention, a method for erasing an audio message is provided. In a specific embodiment, a message is erased by sending an erase command pointing to the first sector of the message. An error is returned if an erase command is sent to erase a sector not having the “begin-of-message” set in the header. Since a sector contains next sector address, the method can trace the linking addresses and erase the whole message from first sector to last sector. The last sector is the one with “end of message” marker set in the header. Of course, there can be other variations, modifications, and alternatives.

The above sequences of processes provide methods for message management for an audio data storage according to various embodiments of the present invention. As shown, the methods uses a combination of processes including a way of providing prerecorded audio messages and voice macro commands for the management of audio messages. Other alternatives can also be provided where processes are added, one or more processes are removed, or one or more processes are provided in a different sequence without departing from the scope of the claims herein. Further details of the present method can be found throughout the present specification.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for audio message management, the method comprising:
providing a flash memory device, the flash memory device including:
a first segment for storing address information;
a second segment for storing prerecorded audio data, a starting address and an ending address associated with the prerecorded audio data being stored in the first segment;
a third segment for storing a plurality of voice macro scripts, each of the plurality of voice macro scripts including one or more voice macro commands, a starting address and an ending address associated with each of the plurality of voice macro scripts being stored in the first segment;
a fourth segment for storing user data and a first sector of a user reserved message; and
a fifth segment for storing at least an audio message, starting address information associated with the audio message being stored in the fourth segment;
receiving an index for one of the plurality of voice macro scripts;
accessing the first segment in the flash memory device for information related to a starting location for the voice macro script associated with the index, the starting location being in the third segment in the flash memory device;
retrieving a voice macro command in the third segment in the flash memory device; and
performing an action according to the retrieved voice macro command.

2. The method of claim 1, wherein the voice macro script comprises:
a voice macro script start marker;
one or more voice macro commands; and
a voice macro script end marker.

3. The method of claim 2, wherein the one or more voice macro commands include a command to playback prerecorded audio data, the method further comprising:
receiving the command to playback prerecorded audio data, the command including a starting address of the prerecorded audio data;
reading the prerecorded audio data in the second segment of the audio storage device; and
playing the prerecorded audio data.

4. The method of claim 2, wherein the one or more voice macro commands include a command to play a recorded audio message, the method further comprising:
receiving the command to playback a recorded audio message, the command including identification information of the recorded audio message;
accessing the fourth segment of the audio storage device to retrieve a starting address for the recorded message;
reading the recorded audio message in the fifth segment of the audio storage device; and
playing the recorded audio message.

5. The method of claim 2, wherein the one or more voice macro commands comprise a command to insert a delay, or a command to play a silence message, or a command to change volume, or a command to change configuration.

6. A method for audio message management, the method comprising:
providing an audio storage device, the audio storage device including:
a first segment for storing address information;
a second segment for storing prerecorded audio data, a starting address and an ending address associated with the prerecorded audio data being stored in the first segment;
a third segment for storing a plurality of voice macro scripts, each of the plurality of voice macro scripts including one or more voice macro commands, a starting address and an ending address associated with each of the plurality of voice macro scripts being stored in the first segment;
a fourth segment for storing user data and a first sector of a user reserved message; and
a fifth segment for storing at least an audio message, starting address information associated with the audio message being stored in the fourth segment;
receiving an index for one of the plurality of voice macro scripts;
accessing the first segment in the audio storage device for information related to a starting location for the voice macro script associated with the index, the starting location being in the third segment in the audio storage device;
retrieving a voice macro command in the third segment in the audio storage device; and
performing an action according to the retrieved voice macro command.

7. The method of claim 6, wherein the audio storage device is a non-volatile memory device.

8. The method of claim 6, wherein the audio storage device is a flash memory device.

9. The method of claim 6, wherein the voice macro script comprises:
a voice macro script start marker;
one or more voice macro commands; and
a voice macro script end marker.

10. The method of claim 9, wherein the one or more voice macro commands include a command to playback prerecorded audio data, the method further comprising:
receiving the command to playback prerecorded audio data, the command including a starting address of the prerecorded audio data;
reading the prerecorded audio data in the second segment of the audio storage device; and
playing the prerecorded audio data.

11. The method of claim 9, wherein the one or more voice macro commands include a command to play a recorded audio message, the method further comprising:
receiving the command to playback a recorded audio message, the command including identification information of the recorded audio message;
accessing the fourth segment of the audio storage device to retrieve a starting address for the recorded message;
reading the recorded audio message in the fifth segment of the audio storage device; and
playing the recorded audio message.

12. The method of claim 9, wherein the one or more voice macro commands comprise a command to insert a delay, or a command to play a silence message, or a command to change volume, or a command to change configuration.

13. The method of claim 6, further comprising:
receiving an audio data;
storing the audio data in the second segment of the audio storage device; and
storing a starting address and an ending address associated the audio data in the first segment of the audio storage device.

14. The method of claim 6, further comprising:
selecting a starting address in the third segment of the audio storage device;
storing the audio data in the third segment of the audio storage device; and
storing the starting address and an ending address of the audio data in the first segment of the audio storage device.

15. The method of claim 6, further comprising:
receiving a command to record an audio message;
selecting an available sector in the fifth segment of the audio storage device;
storing a begin-of-message marker in a header; and
storing the audio message in the sector.

16. The method of claim 15, further comprising:
selecting a second sector for audio message storage; and
storing a second sector address marker in a header of the first sector.

17. The method of claim 15, further comprising:
storing an end of message marker in a header of a last sector for storing the audio message.

18. The method of claim 15, further comprising:
receiving a command to play a recorded audio message, the command including a starting address for the recorded audio message;
reading a header for a end of message marker;
playing the recorded audio message; and
stopping the playing if the end of message marker is found.

19. The method of claim 6, further comprising:
receiving a command to erase a recorded audio message, the command including a starting address for the recorded audio message;
reading a header for a begin-of-message marker;
erasing the recorded audio message; and
sending an error message if the begin-of-message marker is not found.

20. A semiconductor memory device for audio data storage, the memory device comprising:
a first plurality of memory cells for storing address information;
a second plurality of memory cells for storing prerecorded audio data, a starting address of the prerecorded audio data being stored in a selected one of the first plurality of memory cells;
a third plurality of memory cells for storing a voice macro script, a starting address of the voice macro script being stored in a second selected one of the first plurality of memory cells;
a fourth plurality of memory cells for storing user data; and
a fifth plurality of memory cells for recording an audio message, information related to a starting address of the audio message being stored in a selected one the fourth plurality of memory cells.

21. The memory device of claim 20, wherein the prerecorded audio data comprises English words.

22. The memory device of claim 20, wherein the prerecorded audio data comprises foreign language words.

23. The memory device of claim 20, wherein the prerecorded audio data comprises a Beep-tone.

24. The memory device of claim 20, wherein the voice macro script comprises:
a voice macro start marker;
one or more voice macro commands; and
a voice macro end marker;
wherein the one or more voice macro commands include a command to playback a prerecorded audio data, a command to insert a delay, a command to play a silence message, a command to change volume, a command to change configuration, or a command to play a recorded audio message.

25. The database of claim 20, wherein the fourth plurality of memory cells includes a plurality of sectors, the plurality of sectors being characterized by storage capacities in the range of approximately 4 K bytes to 64 K bytes.

26. The database of claim 20, wherein the fifth plurality of memory cells includes a plurality of sectors, the plurality of sectors being characterized by storage capacities in the range of approximately 4 K bytes to 64 K bytes.

27. The method of claim 20, wherein the audio storage device is a non-volatile memory device.

28. The method of claim 20, wherein the audio storage device is a flash memory device.

29. A method for playing an audio message stored in an audio storage device, the method comprising:
receiving an index to a segment in the audio storage device, the segment including a first address for a prerecorded message and a second address for a voice macro script, the voice macro script including a predetermined sequence of voice commands, the index being associated with the second address for the voice macro script;
reading the second address for the voice macro script associated with the index;
retrieving a voice command in the voice macro script;
determining if the voice command includes a command to play a user reserved message;
determining if the user reserved message is recorded in the audio storage device;
if the user reserved message is not recorded in the audio storage device, recording the user reserved message; and
playing the user reserved message.

30. The method of claim 29, wherein the voice macro command includes a command to playback a prerecorded audio data, a command to insert a delay, a command to play a silence message, a command to change volume, a command to change configuration, or a command to play a recorded audio message.

31. The method of claim 29, wherein the audio storage device comprising:
first segment for storing address information;
second segment for storing prerecorded audio data, a starting address and an ending address of the prerecorded audio data being stored in the first segment;
third segment for storing at least a voice macro script, a starting address and an ending address of the voice macro script being stored in the first segment;
fourth segment for storing user data and a first sector of a user reserved message; and
fifth segment for storing at least an audio message, starting address information of the audio message being stored in the fourth segment.
